(19) United States
(12) Patent Application Publication
(10) Pub. No.: US 2026/0342849 A1
(43) Pub. Date: Oct. 29, 2026

(54) AUTONOMOUS COLLABORATIVE WORKSPACE HONEYTOKEN DEPLOYMENT AND MONITORING

(71) Applicant: Horizon 3 AI, Inc., Dover, DE (US)

(72) Inventors: James Walter Horseman, Wesley Chapel, FL (US); Snehal Antani, San Francisco, CA (US)

(21) Appl. No.: 19/190,330

(22) Filed: Apr. 25, 2025

(51) Int. Cl. H04L 9/40

(52) U.S. Cl. CPC H04L 63/1491; H04L 63/1416; H04L 63/1433

(57) ABSTRACT

An autonomous pentesting agent may autonomously deploy honeytokens in a collaborative workspace environment. The agent may obtain, during an autonomous pentest of a network, access to a collaborative workspace environment of the network, the collaborative workspace environment configured to facilitate communications between multiple users of the network. The agent may deploy, within the collaborative workspace environment, one or more honeytokens, where the one or more honeytokens are based on the communications in the collaborative workspace environment, network information obtained via the autonomous pentest, or both. The agent may detect, after deploying the one or more honeytokens, an occurrence of a triggering event associated with access to a honeytoken of the one or more honeytokens, the triggering event indicating unauthorized access to the collaborative workspace environment. The agent may report the occurrence of the triggering event based on the detection.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support autonomous collaborative workspace honeytoken deployment and monitoring.

In some aspects, the techniques described herein relate to a method for autonomous pentesting, including: obtaining, during an autonomous pentest of a network, access to a collaborative workspace environment of the network, the collaborative workspace environment configured to facilitate communications between a plurality of users of the network; deploying, within the collaborative workspace environment, one or more honeytokens, wherein the one or more honeytokens are based at least in part on the communications in the collaborative workspace environment, network information obtained via the autonomous pentest, or both; detecting, after deploying the one or more honeytokens, an occurrence of a triggering event associated with access to a honeytoken of the one or more honeytokens, the triggering event indicating unauthorized access to the collaborative workspace environment; and reporting the occurrence of the triggering event based at least in part on the detection.

In some aspects, the techniques described herein relate to an apparatus for autonomous pentesting, including: one or more memories storing processor-executable code; and one or more processors coupled with the one or more memories and individually or collectively operable to execute the code to cause the apparatus to: obtain, during an autonomous pentest of a network, access to a collaborative workspace environment of the network, the collaborative workspace environment configured to facilitate communications between a plurality of users of the network; deploy, within the collaborative workspace environment, one or more honeytokens, wherein the one or more honeytokens are based at least in part on the communications in the collaborative workspace environment, network information obtained via the autonomous pentest, or both; detect, after deploying the one or more honeytokens, an occurrence of a triggering event associated with access to a honeytoken of the one or more honeytokens, the triggering event indicating unauthorized access to the collaborative workspace environment; and report the occurrence of the triggering event based at least in part on the detection.

In some aspects, the techniques described herein relate to a non-transitory computer-readable medium storing code for autonomous pentesting, the code including instructions executable by one or more processors to: obtain, during an autonomous pentest of a network, access to a collaborative workspace environment of the network, the collaborative workspace environment configured to facilitate communications between a plurality of users of the network; deploy, within the collaborative workspace environment, one or more honeytokens, wherein the one or more honeytokens are based at least in part on the communications in the collaborative workspace environment, network information obtained via the autonomous pentest, or both; detect, after deploying the one or more honeytokens, an occurrence of a triggering event associated with access to a honeytoken of the one or more honeytokens, the triggering event indicating unauthorized access to the collaborative workspace environment; and report the occurrence of the triggering event based at least in part on the detection.

### BRIEF DESCRIPTION OF THE DRAWINGS

FIG. 1 shows an example of a computing environment that supports autonomous collaborative workspace honeytoken deployment and monitoring in accordance with aspects of the present disclosure.

FIG. 2 shows an example of an autonomous pentest map that supports autonomous collaborative workspace honeytoken deployment and monitoring in accordance with aspects of the present disclosure.

FIGS. 3 and 4 show examples of computing environments that support autonomous collaborative workspace honeytoken deployment and monitoring in accordance with aspects of the present disclosure.

FIG. 5 shows an example of a user interface that supports autonomous collaborative workspace honeytoken deployment and monitoring in accordance with aspects of the present disclosure.

FIG. 6 shows a diagram of a system including a device that supports autonomous collaborative workspace honeytoken deployment and monitoring in accordance with aspects of the present disclosure.

FIG. 7 shows a flowchart illustrating methods that support autonomous collaborative workspace honeytoken deployment and monitoring in accordance with aspects of the present disclosure.

### DETAILED DESCRIPTION

Many enterprise networks include or implement a collaborative workspace environment, such as Slack, Teams, Webex, Chanty, or Discord, configured to facilitate communications and file exchanges between users. For example, an organization may use the collaborative workspace environment to exchange messages, perform voice and/or video calls, collaborate on documents, exchange files, or the like. Additionally, the collaborative workspace environment may be integrated with one or more other applications used by the network, including file sharing applications, mail services, security platforms, and the like. Accordingly, the collaborative workspace environment may be a target of attacks on the network, as it may include sensitive data and serve as a launch point to compromise other applications and infiltrate the network. Some networks may implement security measures to protect the collaborative workspace environment from attacks. For example, a network may include perimeter defenses that monitor traffic at a boundary of the network, such as between devices that are part of the network and devices that are external to the network. Additionally, or alternatively, the network may continuously monitor endpoints that connect to the network. However, these security measures may lack detection mechanisms for in-platform behavior. That is, if an attacker were to gain access to the collaborative workspace environment without being blocked or detected by the perimeter defenses or endpoint monitoring, the attacker may obtain unauthorized data and/or access to other applications of the network, as the collaborative workspace environment itself may lack attack detection mechanisms.

An autonomous pentesting agent described herein may deploy honeytokens (also referred to as tripwires, canary tokens, honeypots, lure tokens, monitoring tokens, decoy data, bait records, fake assets, or false flag data) in the collaborative workspace environment. Such honeytokens include digital resources deployed to the collaborative workspace environment that are configured to attract malicious actors and detect security threats. For example, the autonomous pentesting agent may access the collaborative workspace environment—such as via pentesting operations or by receiving credentials from a user configuring the pentest—and deploy honeytokens within the collaborative workspace environment. The autonomous pentesting agent may deploy honeytokens configured to mimic features of the collaborative workspace environment. As an example, the honeytokens may be channels, files, integrated applications, plugins, or other collaborative workspace objects. The honeytokens may be associated with triggering events, such as a change in membership of a channel, export of the files, or access to the integrated application. Detection of such triggering events may trigger reporting and/or remediation. For example, a user associated with the network may receive a notification of a potential attack on the collaborative workspace environment, or the collaborative workspace environment may block export of data and/or be quarantined from integrated applications. In some examples, the autonomous pentesting agent may report triggering events and/or perform remediation operations itself, via a security application installed in the collaborative workspace environment during the pentest, or by integrating with security platforms associated with the network. By deploying honeytokens in the collaborative workspace environment, the autonomous pentesting agent may increase the likelihood that attacks on the collaborative workspace environment are detected and contained, thereby improving network security.

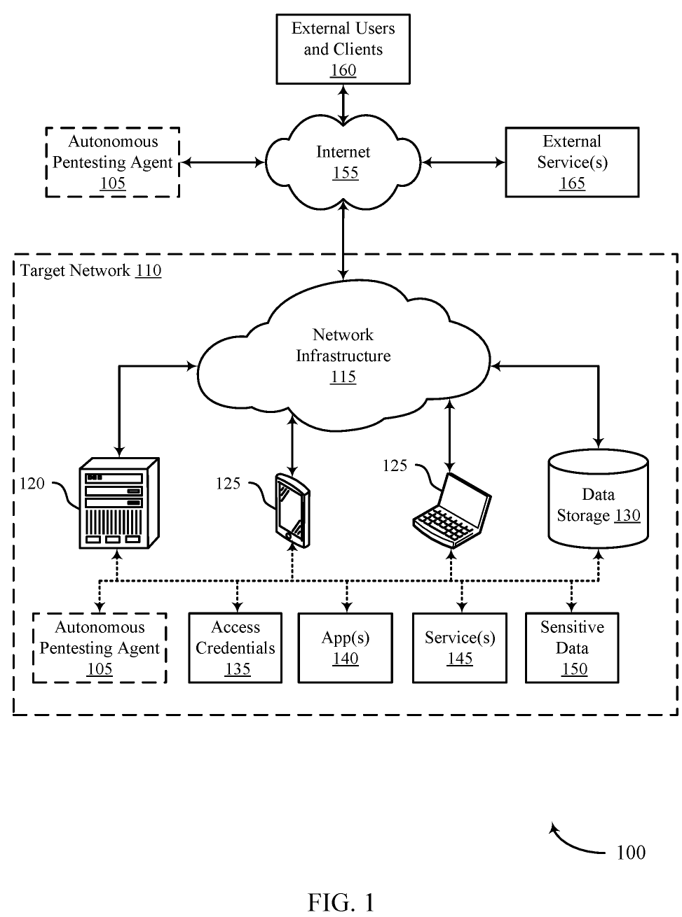

FIG. 1 illustrates an example of a computing environment 100 that supports autonomous collaborative workspace honeytoken deployment and monitoring in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and service(s)145 that are governed or configured by one or more domain controllers and operate in accordance with policies that are put in place and managed by the one or more domain controllers. The domain may be divided into multiple subdomains or groups containing respective subsets of components, users (e.g., access credentials 135), and service(s) 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (access credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

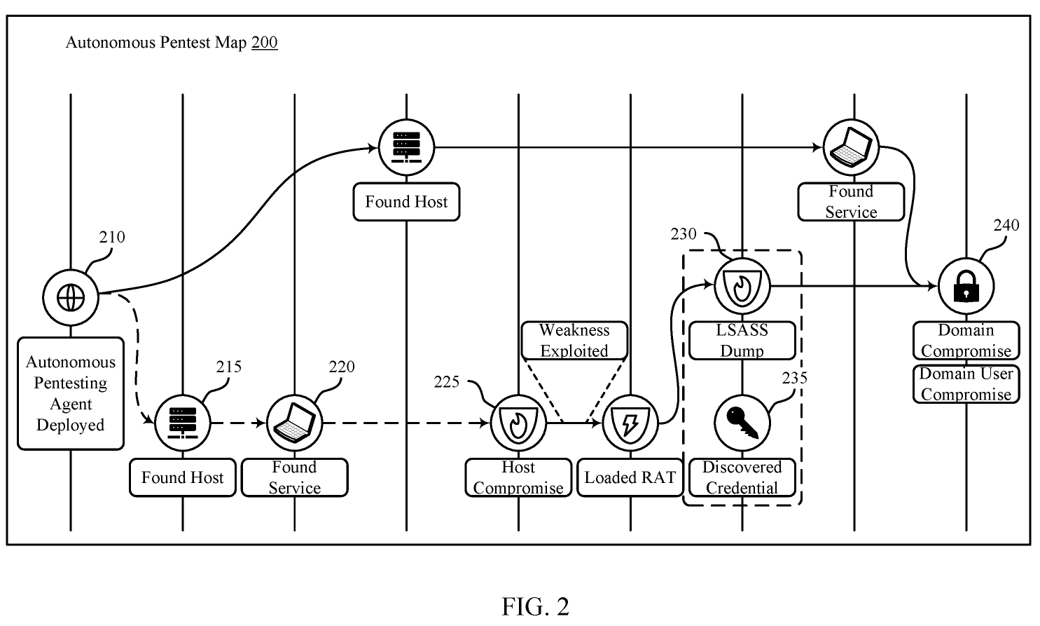

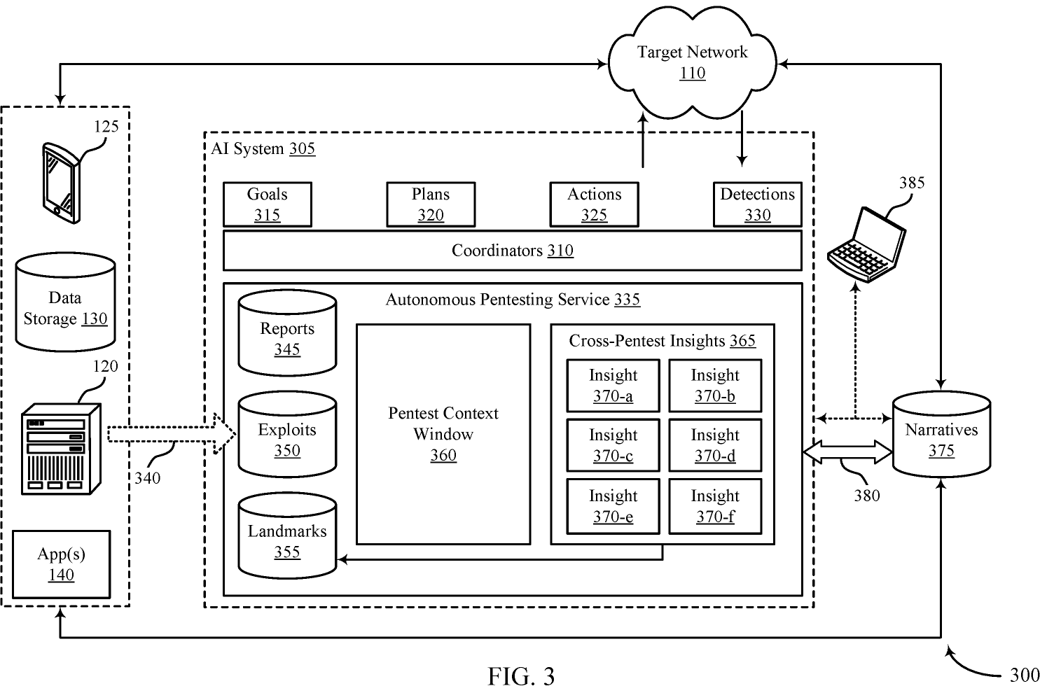

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more artificial intelligence (AI) models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, which enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may perform an autonomous pentest of the target network 110 in which the autonomous pentesting agent 105 may obtain access to and deploy honeytokens within a collaborative workspace environment such as Slack or a similar product. The autonomous pentesting agent 105 (or an application, service, or integration thereof) may detect triggering events associated with accessing the honeytokens. The autonomous pentesting agent 105 may transmit notifications of detected triggering events to a user or security platform associated with the target network 110 and/or perform automatic remediation operations to contain or mitigate a potential threat to the security of the network associated with one or more of the detected triggering events.

By deploying honeytokens as described herein, the autonomous pentesting agent 105 may improve the visibility levels of collaborative workspace environments. Honeytokens may enable detection of suspicious activity within a collaborative workspace environment that other security measures (e.g., perimeter defenses or endpoint monitoring) fail to detect. For example, users of the collaborative workspace environment may perform a wide range of activities—including file downloads, membership additions or changes, access to integrated applications, and the like—which may overlap with malicious attacks, leaving other security measures unable to distinguish non-malicious user activity from malicious attacker activity. By deploying honeytokens that mimic objects—including channels, files, and applications—in the collaborative workspace environment, the autonomous pentesting agent 105 may identify abnormal, malicious activity in ways that other security measures may be unable. That is, honeytoken channels, files, and applications may be decoys and, thus, not used deliberately by users of the target network 110, meaning that access to these honeytokens may be used to detect malicious activity with relatively high confidence.

Additionally, the autonomous pentesting agent 105 may autonomously generate and deploy honeytokens based on characteristics of the target network 110 identified during pentesting, enabling the autonomous pentesting agent 105 to generate honeytokens that mimic features of the collaborative workspace environment specific to the target network 110. For example, the autonomous pentesting agent 105 may generate honeytokens configured to mimic naming structures, product names, team names, groups of users, or the like of the target network 110. Generating the honeytokens based on features of the target network 110 identified during pentesting may enable the autonomous pentesting agent 105 to generate more convincing, and thus more effective, honeytokens. In other words, an attacker may be more likely to engage with a honeytoken generated based on features of the target network 110, as the honeytoken may mimic real channels, files, and applications in the collaborative workspace environment.

Detecting an attack in the collaborative workspace environment may enable the target network 110 to mitigate the impact of the attack. For example, because the collaborative workspace environment may be integrated with other applications of the target network 110, access to the collaborative workspace environment may allow an attacker to breach other parts of the target network 110. By detecting the attack while the attacker is in the collaborative workspace environment through honeytokens (and before the attacker uses the collaborative workspace environment to access other network assets), the autonomous pentesting agent 105 may reduce the severity of the attack.

FIG. 2 shows an example of an autonomous pentest map 200 that supports autonomous collaborative workspace honeytoken deployment and monitoring in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support an autonomous pentest of a target network in which the autonomous pentesting service deploys honeytokens to a collaborative workspace environment. For example, the autonomous pentesting service may obtain access to the collaborative workspace environment, which may be an example of a service involved in the service identification 220 event. The autonomous pentesting service may deploy honeytokens that mimic objects of the collaborative workspace environment—such as channels, files, or integrated applications. The autonomous pentesting service (or an application, service, or integration thereof) may detect triggering events associated with accessing the honeytokens and transmit notifications of detected triggering events to a user of or a security platform associated with the target network.

FIG. 3 shows an example of a computing environment 300 that supports autonomous collaborative workspace honeytoken deployment and monitoring in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service 335 may utilize the AI system 305 to generate honeytokens to be deployed in a collaborative workspace environment. For example, the autonomous pentesting service 335 may obtain access to a collaborative workspace environment (e.g., Slack). The autonomous pentesting service 335 may use the AI system 305 to generate honeytokens that mimic objects of the collaborative workspace environment—such as channels, files, messages, users, bots, or integrated applications. For example, the autonomous pentesting service 335 may use the AI system 305 (e.g., LLM(s) of the AI system 305) to generate conversations within a honeytoken (e.g., decoy) channel based on real conversations in the collaborative workspace environment. The autonomous pentesting service (or an application, service, or integration thereof) may detect triggering events associated with accessing the honeytokens and transmit notifications of detected triggering events to a user of or a security platform associated with the target network.

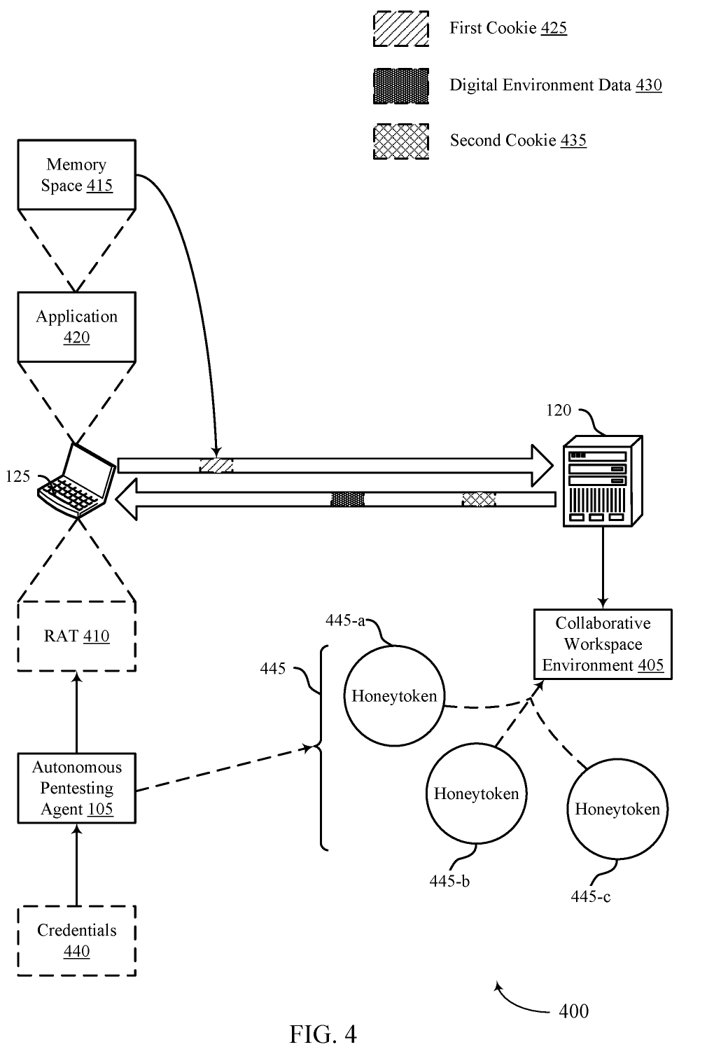

FIG. 4 shows an example of a computing environment 400 that supports autonomous collaborative workspace honeytoken deployment and monitoring in accordance with aspects of the present disclosure. The computing environment 400 may implement or be implemented by the computing environment 100, the autonomous pentest map 200, the computing environment 300, or any combination thereof. For example, the computing environment 400 may illustrate access to a collaborative workspace environment 405 and deployment of honeytokens within the collaborative workspace environment 405 by the autonomous pentesting agent 105.

The autonomous pentesting agent 105 may gain access to the computing device 125. In one example, the autonomous pentesting agent 105 may obtain access to the computing device 125 by deploying a RAT 410 on the computing device 125. The autonomous pentesting agent 105 may deploy the RAT 410 via a phishing email, malicious downloads, exploitation of software vulnerabilities, or the like. In another example, the autonomous pentesting agent 105 may directly access the computing device 125, such as based on a configuration of the autonomous pentest. For example, the autonomous pentesting agent 105 may be deployed to the computing device 125 for the autonomous pentest. The autonomous pentesting agent 105 may perform the operations described herein as part of the autonomous pentest and using access to the computing device 125. Put another way, the access to the computing device 125—via the RAT 410 or otherwise—may serve as the primary tool for the subsequent actions by the autonomous pentesting agent 105, including deployment of the honeytokens.

Additionally, the autonomous pentesting agent 105 may obtain access to the collaborative workspace environment 405. For example, the autonomous pentesting agent 105 may obtain unauthorized access to the collaborative workspace environment 405 via autonomous pentesting operations during an autonomous pentest or may access the collaborative workspace environment 405 by receiving credentials from a user prior to or during the pentest. Stated differently, the autonomous pentesting agent 105 may access the collaborative workspace environment 405 through pentesting operations or through direct credential provisioning from a user.

In examples in which the autonomous pentesting agent 105 obtains access to the collaborative workspace environment 405 via pentesting operations, the autonomous pentesting agent 105 may obtain and use one or more cookies. For example, the autonomous pentesting agent 105 may scan a memory space 415 of the computing device 125 associated with an application 420 (e.g., the memory of the application 420 or of a web browser on the computing device 125) of the collaborative workspace environment 405. The autonomous pentesting agent 105 may scan for and extract a first cookie 425 from the memory space 415. The first cookie 425 may be an example of a user-specific cookie.

The application 420 may be an example of a desktop client application of the collaborative workspace environment 405. The collaborative workspace environment 405 may refer to a tenant, domain, or workspace that is specific to a target network of the computing device 125 (e.g., the target network 110 as described with reference to FIG. 1). The application 420 may be associated with the collaborative workspace environment 405, used by multiple different networks, and have separate digital environments for each of the different networks. For example, the collaborative workspace environment 405 may be specific to the target network (e.g., of the computing device 125) and the collaborative workspace environment 405 may be a part of the application 420. The user of the computing device 125 may have access to the collaborative workspace environment 405 of the application 420, which may include or store information associated with the target network. As an example, the application 420 may be Slack, and the collaborative workspace environment 405 may be a Slack workspace.

Using the first cookie 425, the autonomous pentesting agent 105 may transmit a request to a server 120 associated with the application 420. For example, the autonomous pentesting agent 105 may send a “GET” request to the server 120, where the request includes the first cookie 425 found in the memory space 415. The server 120 may respond to the request with digital environment data 430 associated with the collaborative workspace environment 405. For example, the server 120 may identify that a user account associated with the first cookie 425 (e.g., a user-specific cookie) is a member of the collaborative workspace environment 405 (e.g., a member of a particular tenant) and respond to the request with the digital environment data 430.

The autonomous pentesting agent 105 may scan the digital environment data 430 and identify a uniform resource locator (URL) associated with the collaborative workspace environment 405. Put another way, the autonomous pentesting agent 105 may identify the collaborative workspace environment 405 based on the digital environment data 430. The autonomous pentesting agent 105 may transmit another request including the first cookie 425 to the URL associated with the collaborative workspace environment 405 (e.g., a HTTP GET or POST request to an endpoint of the URL like /whoami, /me, or /user/info). In response, the server 120 may transmit a response that includes a second cookie 435 (e.g., a workspace-specific cookie).

The autonomous pentesting agent 105 may use the first cookie 425 and the second cookie 435 to obtain access to the collaborative workspace environment 405. For example, the autonomous pentesting agent 105 may transmit authenticated requests as a user of the computing device 125 within the collaborative workspace environment 405. The first cookie 425 may allow the autonomous pentesting agent 105 to impersonate the user, and the second cookie 435 may allow the autonomous pentesting agent 105 to access the collaborative workspace environment 405 as the user.

In examples in which the autonomous pentesting agent 105 obtains access to the collaborative workspace environment 405 through direct credential provisioning, the autonomous pentesting agent 105 may receive an indication of credentials 440 associated with a user account of the collaborative workspace environment 405. For example, a user (e.g., associated with a target network of the computing device 125) may create a user account for the autonomous pentesting agent 105 or allow the autonomous pentesting agent 105 to access an existing user account of the application 420. In other words, instead of the autonomous pentesting agent 105 compromising the collaborative workspace environment 405, a user may voluntarily provide or create the credentials 440 (e.g., an application programming interface (API) token) for the autonomous pentesting agent 105.

After accessing the collaborative workspace environment 405, the autonomous pentesting agent 105 may deploy honeytokens 445. For example, the autonomous pentesting agent 105 may deploy, within the collaborative workspace environment 405, a honeytoken 445-a, a honeytoken 445-b, and a honeytoken 445-c based on communications in the collaborative workspace environment 405, network information obtained via an autonomous pentest, or both. The honeytokens 445 may be examples of decoy channels, files, applications, or the like. Examples of honeytokens 445 deployed in the collaborative workspace environment 405 may be described in greater detail elsewhere herein, including with reference to FIG. 4.

Honeytokens include digital resources deployed to the target network to attract malicious actors and detect security threats. A honeytoken may be stored on a network asset—including the collaborative workspace environment 405 used by computing devices—of a target network. When a honeytoken is accessed (e.g., by a malicious actor or otherwise), an alert is transmitted to a network administrator or a program monitoring for security events. In other words, a honeytoken may act as a decoy, designed to mimic a real network asset but configured to transmit an alert when accessed.

In some examples, the autonomous pentesting agent 105 may detect triggering events based on monitoring file-sharing logs of the collaborative workspace environment 405, integrating with an audit logs API of the collaborative workspace environment 405, or both. For example, the autonomous pentesting agent 105 may identify downloads or previews of files in the collaborative workspace environment 405 via the file-sharing logs or audit logs API and detect downloads or previews that may be unauthorized. Put another way, the autonomous pentesting agent 105 may configure the file-sharing logs or audit logs API to monitor for unauthorized access to files in the collaborative workspace environment 405 and transmit alerts when such unauthorized access is detected.

The autonomous pentesting agent 105 may integrate with one or more security platforms and forward triggering events associated with the honeytokens 445 in real-time. For example, the autonomous pentesting agent 105 may detect a triggering event at (e.g., access to) the honeytoken 445-a and forward an indication of the triggering event to a security platform (e.g., a Security Information and Event Management (SIEM) system) associated with the target network. Accordingly, the security platform may perform remediation operations addressing the potential threat associated with the triggering event.

Additionally, or alternatively, the autonomous pentesting agent 105 may integrate the honeytokens 445 with a honeytoken service of an autonomous pentesting service (e.g., a service that deployed the autonomous pentesting agent 105, such as the autonomous pentesting service 335 as described with reference to FIG. 3). For example, the honeytokens 445 may be configured to transmit alerts to the autonomous pentesting platform when triggering events occur, and the autonomous pentesting platform may perform remediation operations and/or alert security teams associated with the target network. Additionally, or alternatively, the autonomous pentesting agent 105 may integrate a honeytoken application with the collaborative workspace environment 405. The honeytokens 445 may indicate detected triggering events to the honeytoken application, which may send alerts to user(s) associated with the target network. In some examples, the honeytoken application (or another application of the autonomous pentesting service) may detect pivot attempts. For example, the honeytoken application may monitor for and detect attempted access to integrated applications from the collaborative workspace environment 405, as well as access to the collaborative workspace environment 405 through the integrated applications.

The autonomous pentesting service (e.g., via the autonomous pentesting agent 105, the honeytoken service, or the honeytoken application) may perform one or more remediation operations in response to detection of a triggering event by the honeytokens 445. For example, the autonomous pentesting service may terminate access to the collaborative workspace environment 405 by a user account that accessed a honeytoken. In other words, the autonomous pentesting service may deactivate or shut down a user account when the user account accesses a honeytoken. Additionally, or alternatively, the autonomous pentesting service may modify one or more attributes of the user account. For example, the autonomous pentesting service may modify permissions of the user account such that the user account is unable to export files, access integrated applications, or perform other operations in the collaborative workspace environment 405, which may limit an impact of a malicious attack. Or, the autonomous pentesting service may trigger a password reset, token rotation, or the like associated with the user account, which may revoke the unauthorized access obtained by an attacker to the user account.

Other examples of remediation operations may include modifying one or more attributes of the collaborative workspace environment 405 (or a portion thereof) corresponding to the triggering event. That is, the autonomous pentesting service may quarantine the collaborative workspace environment 405 or part of the collaborative workspace environment 405 from other network assets of the target network, preventing access to other network assets via the collaborative workspace environment 405. Additionally, or alternatively, the autonomous pentesting service may quarantine data within the collaborative workspace environment 405, including files shared via the collaborative workspace environment 405 and conversations in the collaborative workspace environment 405.

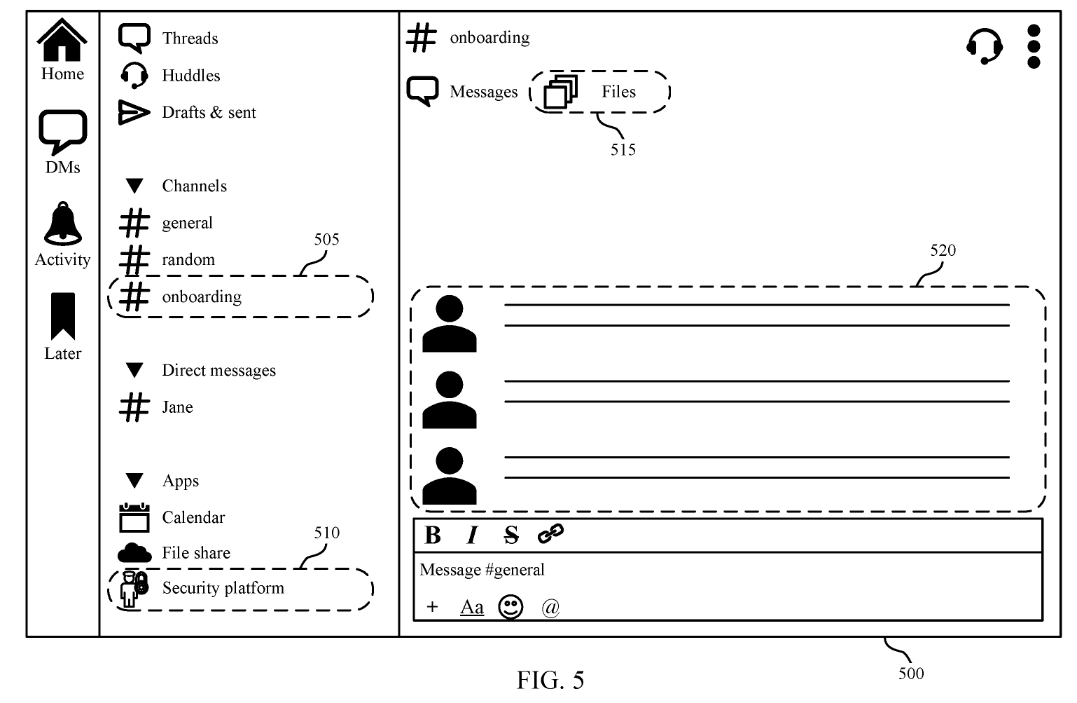

FIG. 5 shows an example of a user interface 500 that supports autonomous collaborative workspace honeytoken deployment and monitoring in accordance with aspects of the present disclosure. The user interface 500 may implement or be implemented by the computing environment 100, the autonomous pentest map 200, the computing environment 300, the computing environment 400, or any combination thereof. For example, the user interface 500 may be an example of a user interface of a collaborative workspace environment, such as Slack, in which an autonomous pentesting agent may deploy honeytokens.

An autonomous pentesting agent—such as the autonomous pentesting agent 105 described with reference to FIGS. 1 and 4—may deploy honeytokens in the collaborative workspace environment. For example, the autonomous pentesting agent may deploy a honeytoken channel 505, a honeytoken app 510, honeytoken files 515, synthetic conversations 520, or any combination thereof.

The autonomous pentesting agent may generate the honeytoken channel 505 to mimic other channels in the collaborative workspace environment and/or imply that the honeytoken channel 505 includes sensitive data. As an example, the autonomous pentesting agent may name the honeytoken channel 505 “onboarding” (as shown in the example of FIG. 5), indicating that the honeytoken channel 505 may include information about where different network assets are within a target network, default login credentials for different apps or services, or other information that may be provided to a new user. Access to the honeytoken channel 505—including opening the channel and requesting membership to the channel—may cause the honeytoken channel 505 to transmit an alert indicating an occurrence of a triggering event. The autonomous pentesting agent may generate synthetic conversations 520 within channels, including the honeytoken channel 505. For example, the autonomous pentesting agent may generate the synthetic conversations 520 using one or more LLMs (e.g., the AI system 305 described with reference to FIG. 3) trained on a sanitized subset of real content from the collaborative workspace environment (e.g., conversations with sensitive data, such as personally identifiable information (PII), removed). By including the synthetic conversations 520 within the honeytoken channel 505, the autonomous pentesting agent may create a more convincing channel that may be more likely to engage an attacker.

Additionally, or alternatively, the autonomous pentesting agent may use the one or more LLMs to determine aspects of other honeytokens described herein. For example, the autonomous pentesting agent may use the one or more LLMs to determine channel titles based on other channels of the collaborative workspace environment (e.g., follow a same naming convention, are related to similar topics, etc.), generate user accounts or profiles (e.g., following a same naming convention of other user accounts, including similar photos, email addresses, etc.), generate honeytoken applications, or the like.

The autonomous pentesting agent may generate a honeytoken app 510 to detect suspicious user actions in the collaborative workspace environment. For example, the honeytoken app 510 may be configured to detect unexpected channel access (e.g., access to a channel by a user account that has not accessed the channel previously), large-scale file downloads (e.g., download amounts exceeding a threshold quantity of files or cumulative download size), or membership changes (e.g., a user account adding an external, unknown account to channels of the collaborative workspace environment).

The autonomous pentesting agent may generate honeytoken files 515 that, when opened, may transmit an alert indicating occurrence of a triggering event. For example, the honeytoken files 515 may transmit alerts when accessed, including when selected for preview, downloaded, screenshotted, or the like. In some examples, an attacker may unknowingly activate the honeytoken files 515 by downloading files en masse from the collaborative workspace environment. In some examples, the honeytoken files 515 may include honeytoken credentials (e.g., embedded tokens, such as AWS or Windows credentials) that, when used, may result in a triggering event.

The autonomous pentesting agent may generate and deploy other types of honeytokens in addition to or alternatively from the honeytokens described herein. For example, the autonomous pentesting agent may deploy generic honeytokens (e.g., open-source honeytokens, such as Canary Tokens), custom-generated honeytokens (e.g., those described herein), or both. Other types of honeytokens may include URLs, Domain Name System (DNS) names, credit cards, quick-response (QR) codes, My Structured Query Language (MySQL) dumps, API keys, Windows commands, file systems, images, certificates, or the like. Honeytokens may be configured to alert a user when the honeytoken is accessed or used. Additionally, or alternatively, honeytokens may be configured to route a suspected attacker to a URL where additional information may be collected about the suspected attacker.

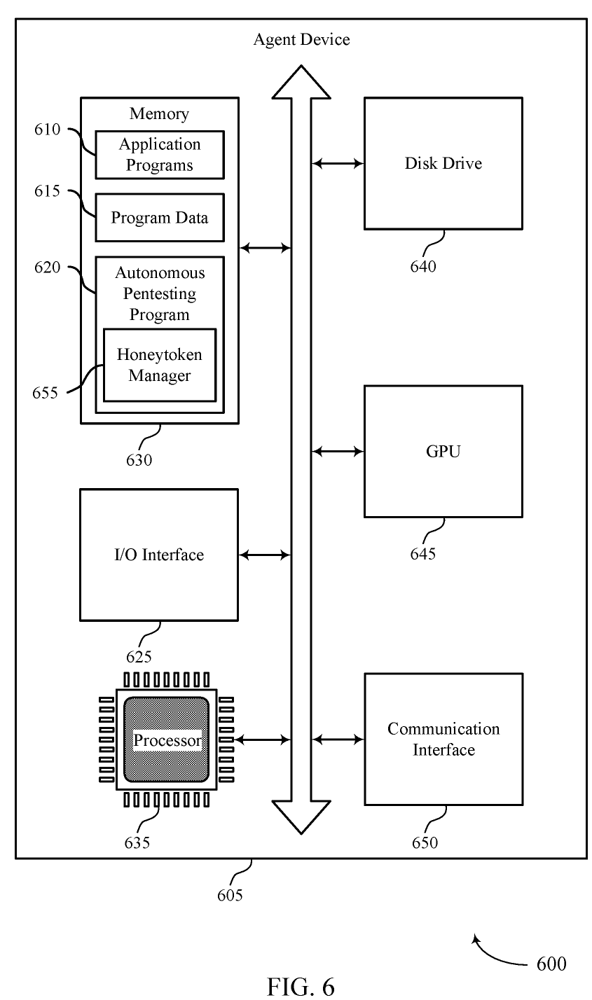

FIG. 6 shows a diagram of a system 600 including an agent device 605 that supports autonomous collaborative workspace honeytoken deployment and monitoring in accordance with aspects of the present disclosure. The agent device 605 may be an example of a device or server on which an autonomous pentesting agent 105 is deployed as described herein. The agent device 605 may include components for autonomous collaborative workspace honeytoken deployment and monitoring, such as a memory 630 including application programs 610, program data 615, an autonomous pentesting program 620, and a honeytoken manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting autonomous collaborative workspace honeytoken deployment and monitoring. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting autonomous collaborative workspace honeytoken deployment and monitoring). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network (e.g., a target network 110 as described herein) accessed by the agent device 605, such as accessed via the communication interface 650. That is, the autonomous pentesting program 620 may be configured to perform an autonomous pentest as described herein, including an autonomous pentest involving autonomous pentesting.

The honeytoken manager 655 may support autonomous pentesting in accordance with examples as disclosed herein. For example, the honeytoken manager 655 may be configured as or otherwise support a means for obtaining, during an autonomous pentest of a network, access to a collaborative workspace environment of the network, the collaborative workspace environment configured to facilitate communications between multiple users of the network. The honeytoken manager 655 may be configured as or otherwise support a means for deploying, within the collaborative workspace environment, one or more honeytokens, where the one or more honeytokens are based on the communications in the collaborative workspace environment, network information obtained via the autonomous pentest, or both. The honeytoken manager 655 may be configured as or otherwise support a means for detecting, after deploying the one or more honeytokens, an occurrence of a triggering event associated with access to a honeytoken of the one or more honeytokens, the triggering event indicating unauthorized access to the collaborative workspace environment. The honeytoken manager 655 may be configured as or otherwise support a means for reporting the occurrence of the triggering event based on the detection.

By including or configuring the honeytoken manager 655 in accordance with examples as described herein, the agent device 605 may support techniques for improved network security.

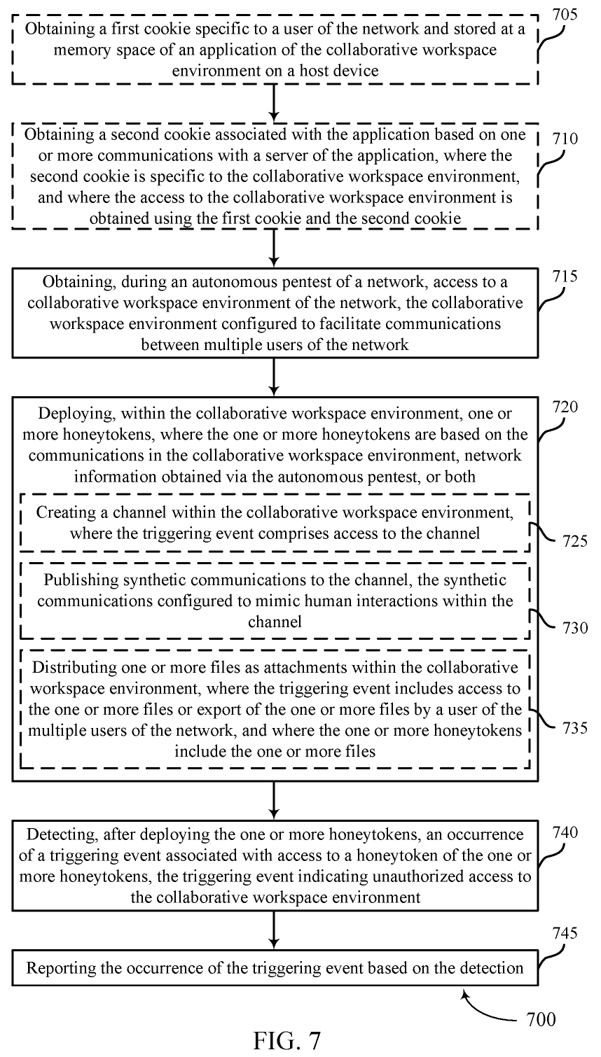

FIG. 7 shows a flowchart illustrating a method 700 that supports autonomous collaborative workspace honeytoken deployment and monitoring in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include obtaining a first cookie specific to a user of the network and stored at a memory space of an application of the collaborative workspace environment on a host device.

At 710, the method 700 may include obtaining a second cookie associated with the application based on one or more communications with a server of the application, where the second cookie is specific to the collaborative workspace environment, and where the access to the collaborative workspace environment is obtained using the first cookie and the second cookie.

At 715, the method 700 may include obtaining, during an autonomous pentest of a network, access to a collaborative workspace environment of the network, the collaborative workspace environment configured to facilitate communications between multiple users of the network.

At 720, the method 700 may include deploying, within the collaborative workspace environment, one or more honeytokens, where the one or more honeytokens are based on the communications in the collaborative workspace environment, network information obtained via the autonomous pentest, or both.

At 725, the method 700 may include creating a channel within the collaborative workspace environment, where the triggering event comprises access to the channel.

At 730, the method 700 may include publishing synthetic communications to the channel, the synthetic communications configured to mimic human interactions within the channel.

At 735, the method 700 may include distributing one or more files as attachments within the collaborative workspace environment, where the triggering event includes access to the one or more files or export of the one or more files by a user of the multiple users of the network, and where the one or more honeytokens include the one or more files.

At 740, the method 700 may include detecting, after deploying the one or more honeytokens, an occurrence of a triggering event associated with access to a honeytoken of the one or more honeytokens, the triggering event indicating unauthorized access to the collaborative workspace environment.

At 745, the method 700 may include reporting the occurrence of the triggering event based on the detection.

The following provides an overview of aspects of the present disclosure:

Aspect 1: A method for autonomous pentesting, comprising: obtaining, during an autonomous pentest of a network, access to a collaborative workspace environment of the network, the collaborative workspace environment configured to facilitate communications between a plurality of users of the network; deploying, within the collaborative workspace environment, one or more honeytokens, wherein the one or more honeytokens are based at least in part on the communications in the collaborative workspace environment, network information obtained via the autonomous pentest, or both; detecting, after deploying the one or more honeytokens, an occurrence of a triggering event associated with access to a honeytoken of the one or more honeytokens, the triggering event indicating unauthorized access to the collaborative workspace environment; and reporting the occurrence of the triggering event based at least in part on the detection.

Aspect 2: The method of aspect 1, further comprising: obtaining a first cookie specific to a user of the network and stored at a memory space of an application of the collaborative workspace environment on a host device; and obtaining a second cookie associated with the application based at least in part on one or more communications with a server of the application, wherein the second cookie is specific to the collaborative workspace environment, wherein the access to the collaborative workspace environment is obtained using the first cookie and the second cookie.

Aspect 3: The method of aspect 1, further comprising: receiving an indication of credentials associated with a user account of the collaborative workspace environment, wherein the access to the collaborative workspace environment is obtained via the user account and using the credentials.

Aspect 4: The method of any of aspects 1 through 3, wherein deploying the one or more honeytokens comprises: creating a channel within the collaborative workspace environment, wherein the triggering event comprises access to the channel.

Aspect 5: The method of aspect 4, further comprising: publishing a plurality of synthetic communications to the channel, the plurality of synthetic communications configured to mimic human interactions within the channel.

Aspect 6: The method of aspect 5, further comprising: training one or more LLMs using a subset of communications of a set of communications of the collaborative workspace environment, wherein the plurality of synthetic communications are generated via the one or more LLMs.

Aspect 7: The method of aspect 6, further comprising: selecting the subset of communications from the set of communications of the collaborative workspace environment based at least in part on an absence of sensitive or confidential information from the subset of communications.

Aspect 8: The method of any of aspects 1 through 7, wherein deploying the one or more honeytokens comprises: distributing one or more files as attachments within the collaborative workspace environment, wherein the triggering event comprises access to the one or more files or export of the one or more files by a user of the plurality of users of the network, and wherein the one or more honeytokens comprise the one or more files.

Aspect 9: The method of any of aspects 1 through 8, wherein deploying the one or more honeytokens comprises: installing one or more applications or plugins in the collaborative workspace environment, wherein the occurrence of the triggering event is reported via the one or more applications and in response to detection of the triggering event by the one or more applications.

Aspect 10: The method of any of aspects 1 through 10, wherein the triggering event comprises one or more of: access to a first channel of the collaborative workspace environment by a user account associated with historical access to one or more second channels different than the first channel, export of a threshold quantity of files from the collaborative workspace environment, or modification of one or more channel access policies of one or more channels of the collaborative workspace environment.

Aspect 11: The method of any of aspects 1 through 10, further comprising: performing one or more remediation operations in response to the triggering event being detected, the one or more remediation operations comprising: termination of the unauthorized access to the collaborative workspace environment, or modification to one or more attributes of a user account, a portion of the collaborative workspace environment, or both corresponding to the access to the honeytoken associated with the triggering event.

Aspect 12: The method of any of aspects 1 through 11, wherein detecting the triggering event comprises: detecting a request to access a first application having an integration with the collaborative workspace environment via a user account of the collaborative workspace environment, wherein the request comprises one or more attributes indicating the unauthorized access to the collaborative workspace environment, and wherein the occurrence of the triggering event is reported in response to detection of the request.

Aspect 13: The method of any of aspects 1 through 12, wherein detecting the triggering event comprises: detecting a request to access the collaborative workspace environment via a first application having an integration with the collaborative workspace environment, wherein the request comprises one or more attributes indicating the unauthorized access to the collaborative workspace environment, and wherein the occurrence of the triggering event is reported in response to detection of the request.

Aspect 14: The method of any of aspects 1 through 13, wherein reporting the occurrence of the triggering event comprises: forwarding an indication of one or more behaviors associated with the occurrence of the triggering event to one or more security operations platforms associated with the network and in response to detection of the triggering event.

Aspect 15: The method of any of aspects 1 through 14, wherein reporting the occurrence of the triggering event comprises: transmitting one or more messages to an API of the collaborative workspace environment via an integration between the API and an autonomous pentesting agent that performs the autonomous pentest of the network.

Aspect 16: The method of any of aspects 1 through 15, wherein the collaborative workspace environment comprises a cloud-based communication platform that facilitates the communications between the plurality of users via one or more communication channels including respective groups of users of the plurality of users and via synchronous and asynchronous audio and video communications.

Aspect 17: The method of aspect 16, wherein the collaborative workspace environment comprises one or more integrations with one or more applications different from an application of the collaborative workspace environment, and wherein information associated with the one or more applications is accessible via the collaborative workspace environment.

Aspect 18: An apparatus for autonomous pentesting, comprising: one or more memories storing processor-executable code; and one or more processors coupled with the one or more memories and individually or collectively operable to execute the code to cause the apparatus to perform a method of any of aspects 1 through 17.

Aspect 19: A non-transitory computer-readable medium storing code for autonomous pentesting, the code comprising instructions executable by one or more processors to perform a method of any of aspects 1 through 17.

Aspect 20: An apparatus for autonomous pentesting, comprising at least one means for performing a method of any aspects 1 through 17.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for autonomous pentesting, comprising:
obtaining, during an autonomous pentest of a network, access to a collaborative workspace environment of the network, the collaborative workspace environment configured to facilitate communications between a plurality of users of the network;
deploying, within the collaborative workspace environment, one or more honeytokens, wherein the one or more honeytokens are based at least in part on the communications in the collaborative workspace environment, network information obtained via the autonomous pentest, or both;
detecting, after deploying the one or more honeytokens, an occurrence of a triggering event associated with access to a honeytoken of the one or more honeytokens, the triggering event indicating unauthorized access to the collaborative workspace environment; and
reporting the occurrence of the triggering event based at least in part on the detection.

2. The method of claim 1, further comprising:
obtaining a first cookie specific to a user of the network and stored at a memory space of an application of the collaborative workspace environment on a host device; and
obtaining a second cookie associated with the application based at least in part on one or more communications with a server of the application, wherein the second cookie is specific to the collaborative workspace environment, wherein the access to the collaborative workspace environment is obtained using the first cookie and the second cookie.

3. The method of claim 1, further comprising:
receiving an indication of credentials associated with a user account of the collaborative workspace environment, wherein the access to the collaborative workspace environment is obtained via the user account and using the credentials.

4. The method of claim 1, wherein deploying the one or more honeytokens comprises:
creating a channel within the collaborative workspace environment, wherein the triggering event comprises access to the channel.

5. The method of claim 4, further comprising:
publishing a plurality of synthetic communications to the channel, the plurality of synthetic communications configured to mimic human interactions within the channel.

6. The method of claim 5, further comprising:
training one or more large language models (LLMs) using a subset of communications of a set of communications of the collaborative workspace environment, wherein the plurality of synthetic communications are generated via the one or more LLMs.

7. The method of claim 6, further comprising:
selecting the subset of communications from the set of communications of the collaborative workspace environment based at least in part on an absence of sensitive or confidential information from the subset of communications.

8. The method of claim 1, wherein deploying the one or more honeytokens comprises:
distributing one or more files as attachments within the collaborative workspace environment, wherein the triggering event comprises access to the one or more files or export of the one or more files by a user of the plurality of users of the network, and wherein the one or more honeytokens comprise the one or more files.

9. The method of claim 1, wherein deploying the one or more honeytokens comprises:
installing one or more applications or plugins in the collaborative workspace environment, wherein the occurrence of the triggering event is reported via the one or more applications and in response to detection of the triggering event by the one or more applications.

10. The method of claim 9, wherein the triggering event comprises one or more of: access to a first channel of the collaborative workspace environment by a user account associated with historical access to one or more second channels different than the first channel, export of a threshold quantity of files from the collaborative workspace environment, or modification of one or more channel access policies of one or more channels of the collaborative workspace environment.

11. The method of claim 1, further comprising:
performing one or more remediation operations in response to the triggering event being detected, the one or more remediation operations comprising:
termination of the unauthorized access to the collaborative workspace environment, or
modification to one or more attributes of a user account, a portion of the collaborative workspace environment, or both corresponding to the access to the honeytoken associated with the triggering event.

12. The method of claim 1, wherein detecting the triggering event comprises:
detecting a request to access a first application having an integration with the collaborative workspace environment via a user account of the collaborative workspace environment, wherein the request comprises one or more attributes indicating the unauthorized access to the collaborative workspace environment, and wherein the occurrence of the triggering event is reported in response to detection of the request.

13. The method of claim 1, wherein detecting the triggering event comprises:
detecting a request to access the collaborative workspace environment via a first application having an integration with the collaborative workspace environment, wherein the request comprises one or more attributes indicating the unauthorized access to the collaborative workspace environment, and wherein the occurrence of the triggering event is reported in response to detection of the request.

14. The method of claim 1, wherein reporting the occurrence of the triggering event comprises:
forwarding an indication of one or more behaviors associated with the occurrence of the triggering event to one or more security operations platforms associated with the network and in response to detection of the triggering event.

15. The method of claim 1, wherein reporting the occurrence of the triggering event comprises:
transmitting one or more messages to an application programming interface (API) of the collaborative workspace environment via an integration between the API and an autonomous pentesting agent that performs the autonomous pentest of the network.

16. The method of claim 1, wherein the collaborative workspace environment comprises a cloud-based communication platform that facilitates the communications between the plurality of users via one or more communication channels including respective groups of users of the plurality of users and via synchronous and asynchronous audio and video communications.

17. The method of claim 16, wherein the collaborative workspace environment comprises one or more integrations with one or more applications different from an application of the collaborative workspace environment, and wherein information associated with the one or more applications is accessible via the collaborative workspace environment.

18. An apparatus for autonomous pentesting, comprising:
one or more memories storing processor-executable code; and
one or more processors coupled with the one or more memories and individually or collectively operable to execute the code to cause the apparatus to:
obtain, during an autonomous pentest of a network, access to a collaborative workspace environment of the network, the collaborative workspace environment configured to facilitate communications between a plurality of users of the network;
deploy, within the collaborative workspace environment, one or more honeytokens, wherein the one or more honeytokens are based at least in part on the communications in the collaborative workspace environment, network information obtained via the autonomous pentest, or both;
detect, after deploying the one or more honeytokens, an occurrence of a triggering event associated with access to a honeytoken of the one or more honeytokens, the triggering event indicating unauthorized access to the collaborative workspace environment; and
report the occurrence of the triggering event based at least in part on the detection.

19. The apparatus of claim 18, wherein the one or more processors are individually or collectively further operable to execute the code to cause the apparatus to:
obtain a first cookie specific to a user of the network and stored at a memory space of an application of the collaborative workspace environment on a host device; and
obtain a second cookie associated with the application based at least in part on one or more communications with a server of the application, wherein the second cookie is specific to the collaborative workspace environment, wherein the access to the collaborative workspace environment is obtained using the first cookie and the second cookie.

20. A non-transitory computer-readable medium storing code for autonomous pentesting, the code comprising instructions executable by one or more processors to:
obtain, during an autonomous pentest of a network, access to a collaborative workspace environment of the network, the collaborative workspace environment configured to facilitate communications between a plurality of users of the network;
deploy, within the collaborative workspace environment, one or more honeytokens, wherein the one or more honeytokens are based at least in part on the communications in the collaborative workspace environment, network information obtained via the autonomous pentest, or both;
detect, after deploying the one or more honeytokens, an occurrence of a triggering event associated with access to a honeytoken of the one or more honeytokens, the triggering event indicating unauthorized access to the collaborative workspace environment; and
report the occurrence of the triggering event based at least in part on the detection.
